(19) United States
(12) Patent Application Publication
(10) Pub. No.: US 2026/0269711 A1
(43) Pub. Date: Sep. 10, 2026

(54) ELECTRONIC CIRCUITRY, POWER CONVERTER, AND DRIVING METHOD

(71) Applicant: Kabushiki Kaisha Toshiba, Kawasaki-shi (JP)

(72) Inventors: Kohei HORII, Kawasaki Kanagawa (JP); Takeshi UENO, Kawasaki Kanagawa (JP); Shusuke KAWAI, Fujisawa Kanagawa (JP); Hiroaki ISHIHARA, Yokohama Kanagawa (JP); Koutaro MIYAZAKI, Taito Tokyo (JP); Yuto BUSHIMATA, Kawasaki Kanagawa (JP)

(21) Appl. No.: 19/534,033

(22) Filed: Feb. 9, 2026

(30) Foreign Application Priority Data
Mar. 7, 2025 (JP) 2025-036640

(51) Int. Cl. H02M 1/084; H02M 1/00; H02M 7/5387

(52) U.S. Cl. CPC H02M 1/084; H02M 1/0009; H02M 1/0058; H02M 7/53871

(57) ABSTRACT

According to one embodiment, an electronic circuitry includes a detector configured to detect a physical quantity corresponding to a time change in an output current of a switching element whose driving is controlled in accordance with a control signal, and to compare the physical quantity with a predetermined value; a current supplier configured to supply a drive current to the switching element; and a controller configured to change a magnitude of the drive current supplied from the current supplier to the switching element in accordance with a comparison result between the physical quantity and the predetermined value.

### CROSS REFERENCE TO RELATED APPLICATIONS

This application is based upon and claims the benefit of priority from the prior Japanese Patent Application No. 2025-036640, filed on Mar. 7, 2025, the entire contents of which are incorporated herein by reference.

### FIELD

Embodiments described herein relate to an electronic circuitry, a power converter, and a driving method.

### BACKGROUND

In a switching element used for a power source circuit, an inverter, or the like, power loss becomes smaller as a transition time in turn-on or turn-off becomes shorter. However, in the turn-on or turn-off of the switching element, electro-magnetic noise (electro-magnetic interference (EMI)) occurs, and the magnitude of the EMI becomes larger as the transition time becomes shorter. That is, the power loss and the EMI are in a trade-off relationship.

In order to adjust such a trade-off, it is conceivable to control a drive current to be supplied to the switching element and to thereby adjust a slew rate (voltage slew rate) of an output voltage in the turn-on or turn-off of the switching element to a desired value. However, for example, in a case where the switching element is a MOSFET, it has been known that a physical mechanism which determines a time change in the output voltage is different between a former half and a latter half of a turn-on transition period. In detail, in the former half of the turn-on transition period, the output voltage lowers mainly due to an effect of a parasitic inductance, but in the latter half of the turn-on transition period, the output voltage lowers due to an effect of a capacitance between a drain and a gate.

A technique has been known which divides the former half and latter half of the turn-on transition period into different phases, switches magnitudes of the drive current between a phase in the former half and a in the latter half, and thereby flexibly controls the voltage slew rate in the turn-on. However, in this technique, a transition timing between the phases is detected based on the time change in the output voltage. Thus, for example, in a case where control is performed such that the voltage slew rate during the turn-on transition period becomes a constant value, time changes in the output voltage in two phases become almost equal, and a transition timing between the phases cannot accurately be detected. As a result, it becomes difficult to accurately control the voltage slew rate.

### BRIEF DESCRIPTION OF THE DRAWINGS

FIG. 1 is a diagram illustrating a configuration of a half-bridge inverter according to a first embodiment;

FIG. 2 is a diagram illustrating a time waveform of each signal in turn-on of a switching element;

FIG. 3 is a diagram illustrating a time waveform of each signal in turn-off of the switching element;

FIG. 4 is a diagram illustrating a detailed configuration of a low-side drive circuit;

FIG. 5 is a diagram illustrating a detailed configuration of a transition timing detector;

FIG. 6 is a diagram illustrating a time waveform of each signal in the turn-on of the switching element;

FIG. 7 is a diagram illustrating a time waveform of each signal in the turn-off of the switching element;

FIG. 8 is a diagram illustrating a truth table of a first multiplexer;

FIG. 9 is a diagram illustrating a truth table of a second multiplexer;

FIG. 10 is a diagram illustrating a configuration of a half-bridge inverter according to a second embodiment;

FIG. 11 is a diagram illustrating a detailed configuration of a low-side drive circuit;

FIG. 12 is a diagram illustrating a detailed configuration of a transition timing detector;

FIG. 13 is a diagram illustrating a time waveform of each signal in the turn-on of the switching element;

FIG. 14 is a diagram illustrating a time waveform of each signal in the turn-off of the switching element;

FIG. 15 is a diagram illustrating a detailed configuration of a first slew rate calculator;

FIG. 16 is a diagram illustrating a detailed configuration of a second slew rate calculator;

FIG. 17 is a diagram illustrating a detailed configuration of a third slew rate calculator; and

FIG. 18 is a diagram illustrating a configuration of a three-phase inverter according to a third embodiment.

### DETAILED DESCRIPTION

According to one embodiment, an electronic circuitry includes a detector configured to detect a physical quantity corresponding to a time change in an output current of a switching element whose driving is controlled in accordance with a control signal, and to compare the physical quantity with a predetermined value; a current supplier configured to supply a drive current to the switching element; and a controller configured to change a magnitude of the drive current supplied from the current supplier to the switching element in accordance with a comparison result between the physical quantity and the predetermined value.

According to one embodiment, a power converter includes a half-bridge circuit including two switching elements; and two drive circuits configured to respectively drive the two switching elements in accordance with control signals. Each of the two drive circuits includes: a detector configured to detect a physical quantity corresponding to a time change in an output current of the switching element controlled by the drive circuit itself, and to compare the physical quantity with a predetermined value; a current supplier configured to supply a drive current to the switching element; and a controller configured to change a magnitude of the drive current supplied from the current supplier to the switching element in accordance with a comparison result between the physical quantity and the predetermined value.

According to one embodiment, a driving method includes: detecting a physical quantity corresponding to a time change in an output current of a switching element whose driving is controlled in accordance with a control signal, and comparing the physical quantity with a predetermined value; and changing a magnitude of a drive current supplied from a current supplier to the switching element in accordance with a comparison result between the physical quantity and the predetermined value.

The present embodiments will hereinafter be described with reference to the drawings. In the drawings, the same reference characters will be given to the same or corresponding elements, and detailed descriptions thereof will appropriately be skipped.

### First Embodiment

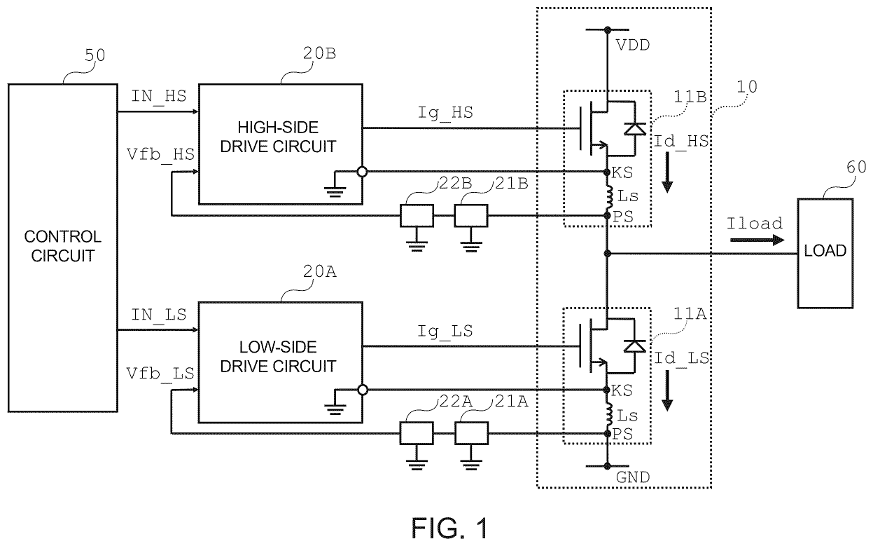

FIG. 1 is a diagram illustrating a configuration of a half-bridge inverter as a power converter according to a first embodiment. The half-bridge inverter includes a half-bridge circuit 10, a low-side drive circuit 20A, a high-side drive circuit 20B, and a control circuit 50. A load 60 is connected to an output of the half-bridge inverter.

The half-bridge circuit 10 includes a switching element 11A on a low side and a switching element 11B on a high side, whose driving is controlled in accordance with control signals to be supplied from the control circuit 50. For example, each of the switching elements 11A and 11B may be an N-channel metal-oxide-semiconductor field-effect transistor (MOSFET). In this case, each of the switching elements 11A and 11B may have a Kelvin source terminal (KS) in addition to terminals of gate, drain, and power source (PS). Hereinafter, descriptions will be made on the assumption that each of the switching elements 11A and 11B has the Kelvin source terminal (KS), but an applicable range of the technique according to the present first embodiment is not limited to a MOSFET having the Kelvin source terminal (KS).

Alternatively, each of the switching elements 11A and 11B may be an N-channel insulated-gate bipolar transistor (IGBT). In this case, each of the switching elements 11A and 11B may have a Kelvin emitter terminal (KE) in addition to terminals of gate, collector, and power emitter (PE). However, an applicable range of the technique according to the present first embodiment is not limited to an IGBT having the Kelvin source terminal (KS).

The drain of the switching element 11A on the low side is connected to the power source PS of the switching element 11B on the high side. The Kelvin source KS of the switching element 11A is connected to a ground of the low-side drive circuit 20A. A parasitic inductance Ls (the parasitic inductance Ls on the low side) is included between the Kelvin source KS and the power source PS of the switching element 11A. The power source PS of the switching element 11A is connected to a ground GND of the half-bridge inverter. The power source PS of the switching element 11A is connected to the low-side drive circuit 20A via an attenuator 21A and a DC bias circuit 22A. The attenuator 21A and the DC bias circuit 22A are connected to the same ground as the low-side drive circuit 20A.

The drain of the switching element 11B on the high side is connected to a power source voltage VDD of the half-bridge inverter. The Kelvin source KS of the switching element 11B is connected to a ground of the high-side drive circuit 20B. A parasitic inductance Ls (the parasitic inductance Ls on the high side) is included between the Kelvin source KS and the power source PS of the switching element 11B. The power source PS of the switching element 11B is connected to the high-side drive circuit 20B via an attenuator 21B and a DC bias circuit 22B. The attenuator 21B and the DC bias circuit 22B are connected to the same ground as the high-side drive circuit 20B.

In the present first embodiment, each of the grounds of the low-side drive circuit 20A and the high-side drive circuit 20B is separated from the ground GND of the half-bridge inverter. The switching elements 11A and 11B and the drive circuits 20A and 20B may be included in separate IC packages or may be included in the same IC package. The switching elements 11A and 11B and the drive circuits 20A and 20B may be mounted on different semiconductor substrates or may be mounted on the same semiconductor substrate.

As for a direction of a current (load current) Iload to be supplied from the half-bridge inverter to the load 60, a direction of a flow from the half-bridge circuit 10 to the load 60 is defined as positive, and a direction of a flow from the load 60 to the half-bridge circuit 10 is defined as negative. However, those may conversely be defined.

In accordance with a low-side control signal IN_LS to be supplied from the control circuit 50, the low-side drive circuit 20A supplies a gate current (a drive current on the low side) Ig_LS to the switching element 11A on the low side. In detail, in a case where the low-side control signal IN_LS is Hi (for example, +5 V), the drive current Ig_LS flows from the drive circuit 20A to the gate of the switching element 11A. In other words, a positive drive current Ig_LS is supplied from the drive circuit 20A to the switching element 11A. On the other hand, in a case where the low-side control signal IN_LS is Lo (for example, 0 V), the drive current Ig_LS flows from the gate of the switching element 11A to the drive circuit 20A. In other words, a negative drive current Ig_LS is supplied from the drive circuit 20A to the switching element 11A.

Similarly, in accordance with a high-side control signal IN_HS to be supplied from the control circuit 50, the high-side drive circuit 20B supplies a gate current (a drive current on the high side) Ig_HS to the switching element 11B on the high side. In detail, in a case where the high-side control signal IN_HS is Hi (for example, +5 V), the drive current Ig_HS flows from the drive circuit 20B to the gate of the switching element 11B. In other words, a positive drive current Ig_HS is supplied from the drive circuit 20B to the switching element 11B. On the other hand, in a case where the high-side control signal IN_HS is Lo (for example, 0 V), the drive current Ig_HS flows from the gate of the switching element 11B to the drive circuit 20B. In other words, a negative drive current Ig_HS is supplied from the drive circuit 20B to the switching element 11B.

The control circuit 50 supplies the low-side control signal IN_LS to the low-side drive circuit 20A and supplies the high-side control signal IN_HS to the high-side drive circuit 20B. The load 60 is an arbitrary electronic device or electric device which is driven by alternating-current power. For example, in a case where the load 60 is an alternating-current motor, the control circuit 50 supplies a PWM-modulated low-side control signal IN_LS to the low-side drive circuit 20A and supplies a PWM-modulated high-side control signal IN_HS to the high-side drive circuit 20B. Alternatively, the half-bridge inverter may be installed in power source equipment such as a PV inverter for solar photovoltaic generation. In this case, an output of the half-bridge circuit 10 is connected to an electricity network instead of the load 60.

The attenuator 21A on the low side is configured with a capacitance or resistance, which is connected in series, for example, and outputs a voltage resulting from voltage division, at a predetermined ratio, of a voltage of the power source PS of the switching element 11A. In detail, when the voltage of the power source PS of the switching element 11A is set as Vps, an output voltage Va of the attenuator 21A is expressed by the following equation (1).

$$[ Math . 1 ]$$

$${V}_{a} = α {V}_{p s} \qquad ( 1 )$$

However, in the above equation (1), “α” represents a voltage division scale for the attenuator 21A and is set to a predetermined value in a range of 0<α<1.

The DC bias circuit 22A on the low side is configured with a resistance and a constant voltage source, for example, and outputs a voltage resulting from addition of a predetermined bias voltage Vbias to the output voltage Va of the attenuator 21A (i.e., the sum of a predetermined bias voltage Vbias and the output voltage Va of the attenuator 21A). Consequently, an output voltage Vb of the DC bias circuit 22A is expressed by the following equation (2).

$$[ Math . 2 ]$$

$${V}_{b} = {V}_{a} + {V}_{bias} = α {V}_{p s} + {V}_{bias} \qquad ( 2 )$$

As described above, the Kelvin source KS of the switching element 11A is connected to the ground of the low-side drive circuit 20A. Thus, for the low-side drive circuit 20A, a voltage Vps of the power source PS of the switching element 11A is equal to a voltage VIs which is produced at both ends of the parasitic inductance Ls of the switching element 11A.

The attenuator 21A and the DC bias circuit 22A are connected to the same ground as the low-side drive circuit 20A. Consequently, a voltage Vfb_LS, which is input to the low-side drive circuit 20A via the attenuator 21A and the DC bias circuit 22A, is expressed by the following equation (3) by using the voltage VIs (=Vps), which is produced at both ends of the parasitic inductance Ls of the switching element 11A.

$$[ Math . 3 ]$$

$${V}_{fb} \_LS = α {V}_{ls} + {V}_{bias} \qquad ( 3 )$$

The voltage VIs, which is produced at both ends of the parasitic inductance Ls of the switching element 11A, is caused due to a time change in a drain current (output current) Id_LS of the switching element 11A, and between both of those, the following relational expression (4) holds true.

$$[ Math . 4 ]$$

$${V}_{l s} = - {L}_{s} \frac{d ( {I}_{{d}_{-}} L S )}{d t} \qquad ( 4 )$$

By substituting the equation (4) into the equation (3), the following relational expression (5) is obtained.

$$[ Math . 5 ]$$

$${V}_{fb} \_LS = - α {L}_{s} \frac{d ( {I}_{{d}_{-}} L S )}{d t} + {V}_{b i a s} \qquad ( 5 )$$

The above equation (5) expresses that the voltage Vfb_LS to be input to the low-side drive circuit 20A is a physical quantity which corresponds to the time change in the output current Id_LS of the switching element 11A. In other words, the low-side drive circuit 20A can acquire the voltage Vfb_LS as the physical quantity which corresponds to the time change in the output current Id_LS of the switching element 11A.

The above argument similarly holds true about the high-side drive circuit 20B. Consequently, the high-side drive circuit 20B can acquire a voltage Vfb_HS as a physical quantity which corresponds to a time change in an output current Id_HS of the switching element 11B.

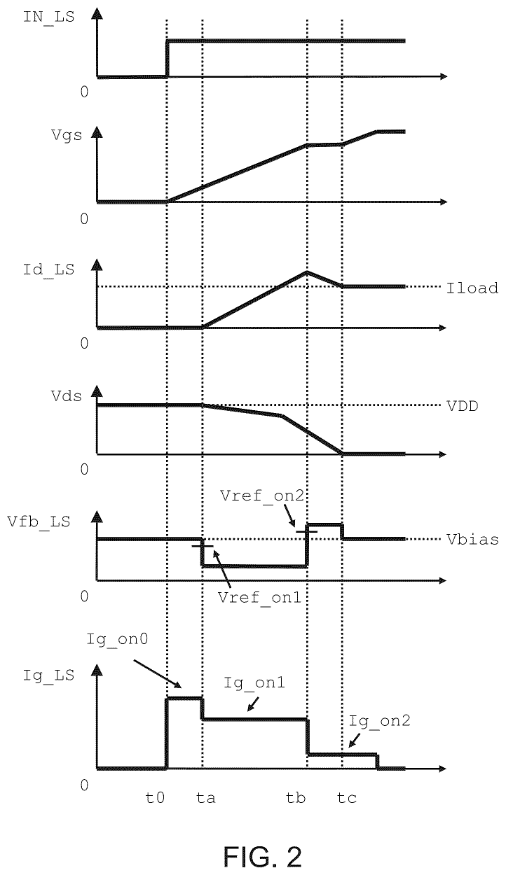

FIG. 2 is a diagram illustrating a time waveform of each signal in turn-on of the switching element 11A. The highest section illustrates a time waveform of the low-side control signal IN_LS. The second section illustrates a time waveform of a voltage Vgs between the gate and the source of the switching element 11A. The third section illustrates a time waveform of the drain current Id_LS of the switching element 11A. The fourth section illustrates a time waveform of a voltage Vds between the drain and the source of the switching element 11A. The fifth section illustrates a time waveform of the voltage Vfb_LS. The sixth section illustrates a time waveform of the drive current Ig_LS to be supplied to the switching element 11A.

At a time point t0, the control signal IN_LS changes from Lo to Hi, and supply of the drive current Ig_LS from the low-side drive circuit 20A to the switching element 11A is started. Accordingly, the voltage Vgs between the gate and the source of the switching element 11A starts to rise.

At a time point ta, when the voltage Vgs between the gate and the source exceeds a threshold voltage, the drain current Id_LS starts to flow, and a voltage (output voltage) Vds_LS between the drain and the source starts to lower. At a time point tb, the drain current Id_LS reaches a maximum value of overshoot. At a time point tc, when the drain current Id_LS becomes equal to the load current Iload, the voltage Vds between the drain and the source becomes zero.

In the present first embodiment, a turn-on transition period (a period from the time points t0 to tc in FIG. 2) is divided into three phases of an “initial phase”, a “first phase”, and a “second phase”. The initial phase is a period after the control signal IN_LS becomes Hi and supply of the drive current Ig_LS is started until the drain current Id_LS starts to flow (a period from the time points t0 to ta in FIG. 2). This period is a period in which a capacitance Cgs between the gate and the source (not illustrated) and a capacitance Cgd between the gate and the drain (not illustrated) of the switching element 11A are charged by the drive current Ig_LS, and the voltage Vds between the drain and the source does not change.

The first phase is a period after the drain current Id_LS starts to flow until it reaches the maximum value of the overshoot (a period from the time points ta to tb in FIG. 2), and a time change in the voltage Vds between the drain and the source in this period is expressed by the following equation (6).

$$\begin{matrix}[ Math . 6 ] & \\ {V}_{ds} ( t ) = {V}_{DD} - {L}_{s} \frac{d ( {I}_{d} \_LS )}{dt} & ( 6 )\end{matrix}$$

However, in the above equation (6), “VDD” represents the power source voltage of the half-bridge inverter, and “Ls” represents the parasitic inductance of the switching element 11A.

The second phase is a period after the drain current Id_LS starts to decrease from the maximum value of the overshoot until it becomes equal to the load current Iload (a period from the time points tb to tc in FIG. 2), and the time change in the voltage Vds between the drain and the source in this period is approximately expressed by the following equation (7).

$$\begin{matrix}[ Math . 7 ] & \\ {V}_{ds} ( t ) = {V}_{ds 0} - ( \frac{{I}_{g} \_LS}{{C}_{gd}} ) t & ( 7 )\end{matrix}$$

However, in the above equation (7), “Ig_LS” represents the gate current (drive current) of the switching element 11A, “Vds0” represents the voltage between the drain and the source around a boundary between the first phase and the second phase (the time point tb in FIG. 2), more accurately at a time point when a drain current Id becomes equal to the load current Iload before the time point tb, and “Cgd” represents the capacitance between the gate and the drain (not illustrated) of the switching element 11A.

The low-side drive circuit 20A supplies the drive current Ig_LS, whose magnitudes can respectively be different among the phases, and thereby separately controls a slew rate (voltage slew rate) of the voltage Vds between the drain and the source of the switching element 11A for each of the phases. That is, the magnitude of the drive current Ig_LS is changed at a transition timing when the phases are switched, and the voltage slew rate is thereby controlled for each of the phases.

In detail, in the initial phase (the period from the time points t0 to ta in FIG. 2), the low-side drive circuit 20A supplies the drive current Ig_LS having a predetermined current value Ig_on0 to the switching element 11A. For example, the current value Ig_on0 may be a maximum current value in a positive direction (a direction from the drive circuit 20A to the switching element 11A), the maximum current value being suppliable by the low-side drive circuit 20A. Alternatively, the current value Ig_on0 may be the same as a current value Ig_on1 which will next be described.

Next, the low-side drive circuit 20A detects a timing (the time point ta in FIG. 2) when the voltage Vfb_LS falls below a predetermined threshold voltage Vref_on1 (first predetermined value) and thereby detects a transition timing (first transition timing) from the initial phase to the first phase. The threshold voltage Vref_on1 is set to a value slightly lower than the bias voltage Vbias of the DC bias circuit 22A.

In the first phase (the period from the time points ta to tb in FIG. 2), the low-side drive circuit 20A supplies, to the switching element 11A, the drive current Ig_LS having the predetermined current value Ig_on1 which can be different from the above current value Ig_on0. The current value Ig_on1 is experimentally determined in advance such that a slew rate SR_on1 of the voltage Vds between the drain and the source becomes a desired value, the slew rate SR_on1 being defined by the following equation (8).

$$\begin{matrix}[ Math . 8 ] & \\ SR\_on1 = \frac{{V}_{ds} ( {t}_{a} ) - {V}_{ds} ( {t}_{b} )}{{t}_{b} - {t}_{a}} = \frac{{V}_{DD} - {V}_{ds} ( {t}_{b} )}{{t}_{b} - {t}_{a}} & ( 8 )\end{matrix}$$

Next, the low-side drive circuit 20A detects a timing (the time point tb in FIG. 2) when the voltage Vfb_LS becomes higher than a predetermined threshold voltage Vref_on2 (second predetermined value) and thereby detects a transition timing (second transition timing) from the first phase to the second phase. The threshold voltage Vref_on2 is set to a value slightly higher than the bias voltage Vbias of the DC bias circuit 22A.

In the second phase (the period from the time points tb to tc in FIG. 2), the low-side drive circuit 20A supplies, to the switching element 11A, the drive current Ig_LS having a predetermined current value Ig_on2 which can be different from the above current value Ig_on1. The current value Ig_on2 is experimentally determined in advance such that a slew rate SR_on2 of the voltage Vds between the drain and the source becomes a desired value, the slew rate SR_on2 being defined by the following equation (9).

$$\begin{matrix}[ Math . 9 ] & \\ SR\_on2 = \frac{{V}_{ds} ( {t}_{b} ) - {V}_{ds} ( {t}_{c} )}{{t}_{c} - {t}_{b}} = \frac{{V}_{ds} ( {t}_{b} )}{{t}_{c} - {t}_{b}} & ( 9 )\end{matrix}$$

As described above, the low-side drive circuit 20A divides the turn-on transition period of the switching element 11A into three phases and detects the transition timing between the phases based on the voltage Vfb_LS as the physical quantity which corresponds to the time change in the drain current Id_LS. The low-side drive circuit 20A supplies the drive current Ig_LS, whose magnitudes can respectively be different among the phases, and thereby separately controls the slew rate of the voltage Vds between the drain and the source of the switching element 11A for each of the phases.

The above argument similarly holds true about the high-side drive circuit 20B. Consequently, the high-side drive circuit 20B divides the turn-on transition period of the switching element 11B into three phases and detects the transition timing between the phases based on a voltage Vfb_HS as a physical quantity which corresponds to a time change in a drain current Id_HS. The high-side drive circuit 20B supplies the drive current Ig_HS, whose magnitudes can respectively be different among the phases, and thereby separately controls the slew rate of the voltage Vds between the drain and the source of the switching element 11B for each of the phases.

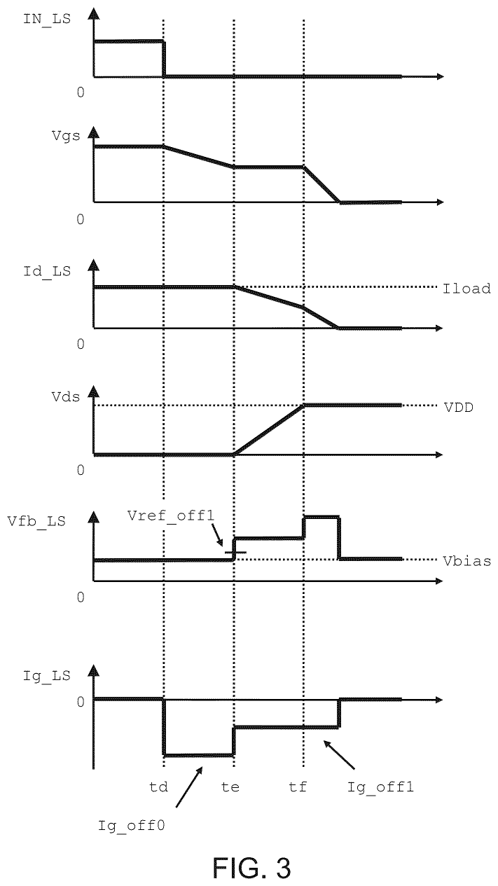

FIG. 3 is a diagram illustrating a time waveform of each signal in turn-off of the switching element 11A. The highest section illustrates a time waveform of the low-side control signal IN_LS. The second section illustrates a time waveform of the voltage Vgs between the gate and the source of the switching element 11A. The third section illustrates a time waveform of the drain current Id_LS of the switching element 11A. The fourth section illustrates a time waveform of the voltage Vds between the drain and the source of the switching element 11A. The fifth section illustrates a time waveform of the voltage Vfb_LS. The sixth section illustrates a time waveform of the drive current Ig_LS to be supplied to the switching element 11A.

At a time point td, the control signal IN_LS changes from Hi to Lo, and supply of the drive current Ig_LS from the switching element 11A toward the low-side drive circuit 20A, that is, the negative drive current Ig_LS (<0) is started. Accordingly, the voltage Vgs between the gate and the source of the switching element 11A starts to lower.

At a time point te, the drain current Id_LS starts to decrease, and the voltage Vds between the drain and the source starts to rise. At a time point tf, in a Miller plateau region, the rise of the voltage Vds between the drain and the source stops, but the drain current Id_LS continues to decrease.

In the present first embodiment, a turn-off transition period (a period from the time points td to tf in FIG. 3) is divided into two phases of an “initial phase” and a “third phase”. The initial phase is a period after the control signal IN_LS becomes Lo and supply of the negative drive current Ig_LS is started until the drain current Id_LS starts to decrease (a period from the time points td to te in FIG. 3). This period is a period in which the capacitance Cgs between the gate and the source (not illustrated) and the capacitance Cgd between the gate and the drain (not illustrated) of the switching element 11A are discharged by the negative drive current Ig_LS, and the voltage Vds between the drain and the source does not change. The third phase is a period after the voltage Vds between the drain and the source starts to rise until it becomes VDD (a period from the time points te to tf in FIG. 3).

The low-side drive circuit 20A supplies the drive current Ig_LS, whose magnitudes can respectively be different between the phases, and thereby controls the slew rate of the voltage Vds between the drain and the source of the switching element 11A.

In detail, in the initial phase (the period from the time points td to te in FIG. 3), the low-side drive circuit 20A supplies the drive current Ig_LS having a predetermined current value Ig_off0 to the switching element 11A. For example, the current value Ig_off0 may be a maximum current value in a negative direction (a direction from the switching element 11A to the drive circuit 20A), the maximum current value being suppliable by the low-side drive circuit 20A. Alternatively, the current value Ig_off0 may be the same as a current value Ig_off1 which will next be described.

Next, the low-side drive circuit 20A detects a timing (the time point te in FIG. 3) when the voltage Vfb_LS becomes higher than a predetermined threshold voltage Vref_off1 (third predetermined value) and thereby detects a transition timing (third transition timing) from the initial phase to the third phase. The threshold voltage Vref_off1 is set to a value higher than the bias voltage Vbias of the DC bias circuit 22A.

In the third phase (the period from the time points te to tf in FIG. 3), the low-side drive circuit 20A supplies, to the switching element 11A, the drive current Ig_LS having the predetermined current value Ig_off1 which can be different from the above current value Ig_off0. The current value Ig_off1 is experimentally determined in advance such that a slew rate SR_off1 of the voltage Vds between the drain and the source becomes a desired value, the slew rate SR_off1 being defined by the following equation (10).

$$\begin{matrix}[ Math . 10 ] & \\ SR\_off1 = \frac{{V}_{ds} ( {t}_{f} ) - {V}_{ds} ( {t}_{e} )}{{t}_{f} - {t}_{e}} = \frac{{V}_{DD}}{{t}_{f} - {t}_{e}} & ( 10 )\end{matrix}$$

As described above, the low-side drive circuit 20A divides the turn-off transition period of the switching element 11A into two phases and detects the transition timing between the phases based on the voltage Vfb_LS as the physical quantity which corresponds to the time change in the drain current Id_LS. The low-side drive circuit 20A supplies the drive current Ig_LS, whose magnitudes can respectively be different between the phases, and thereby controls the slew rate of the voltage Vds between the drain and the source of the switching element 11A.

The above argument similarly holds true about the high-side drive circuit 20B. Consequently, the high-side drive circuit 20B divides the turn-off transition period of the switching element 11B into two phases and detects the transition timing between the phases based on the voltage Vfb_HS as the physical quantity which corresponds to the time change in the drain current Id_HS. The high-side drive circuit 20B supplies the drive current Ig_HS, whose magnitudes can respectively be different between the phases, and thereby controls the slew rate of the voltage Vds between the drain and the source of the switching element 11B.

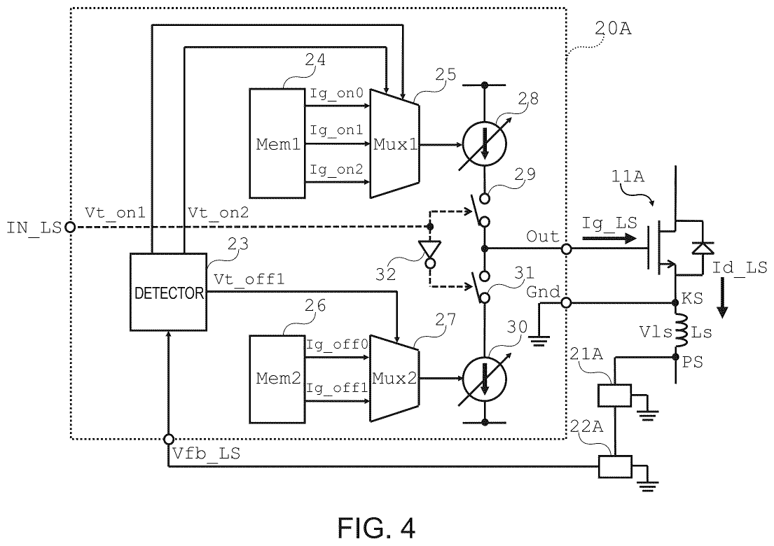

FIG. 4 is a diagram illustrating a detailed configuration of the low-side drive circuit 20A. Note that because a configuration of the high-side drive circuit 20B is similar, only the configuration of the low-side drive circuit 20A will be described in the following description. The low-side drive circuit 20A includes a transition timing detector (detector) 23, a first storage 24 and a first multiplexer 25, and a second storage 26 and a second multiplexer 27. Configuration elements 24 to 27 configure a controller of the low-side drive circuit 20A. The low-side drive circuit 20A includes a first variable current source 28 and a first switch 29, a second variable current source 30 and a second switch 31, and a NOT gate 32. Configuration elements 28 to 32 configure a current supplier of the low-side drive circuit 20A.

The transition timing detector 23 detects the transition timing among the phases of the switching element 11A based on the voltage Vfb_LS as the physical quantity which corresponds to the time change in the drain current Id_LS of the switching element 11A.

In detail, the transition timing detector 23 outputs three timing detection signals Vt_on1, Vt_on2, and Vt_off1 based on the voltage Vfb_LS. A value of the timing detection signal Vt_on1 is inverted at the first transition timing (the time point ta in FIG. 2) from the initial phase to the first phase in the turn-on transition period. A value of the timing detection signal Vt_on2 is inverted at the second transition timing (the time point tb in FIG. 2) from the first phase to the second phase in the turn-on transition period. A value of the timing detection signal Vt_off1 is inverted at the third transition timing (the time point te in FIG. 3) from the initial phase to the third phase in the turn-off transition period.

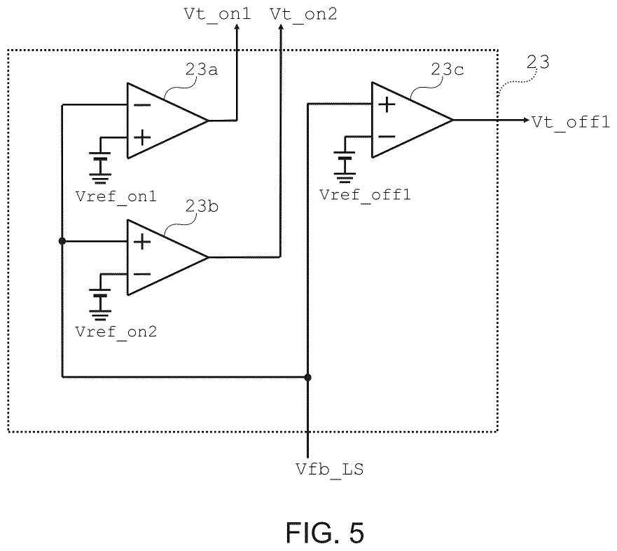

FIG. 5 is a diagram illustrating a detailed configuration of the transition timing detector 23. The transition timing detector 23 includes comparators 23a, 23b, and 23e and constant voltage sources Vref_on1, Vref_on2, and Vref_off1.

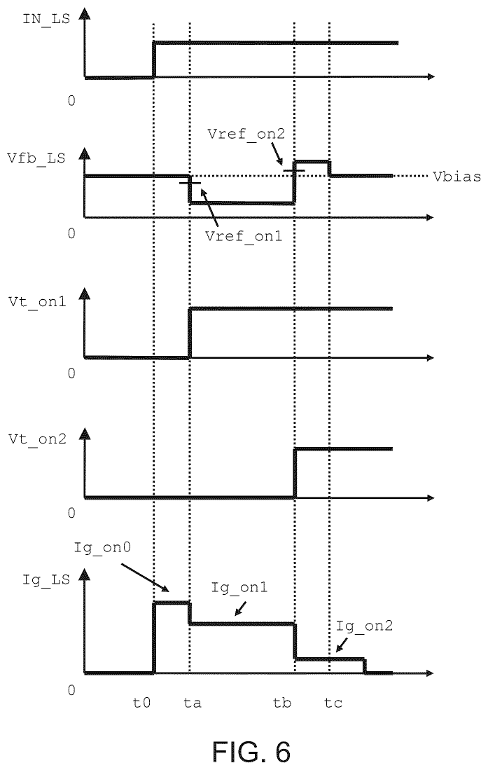

FIG. 6 is a diagram illustrating a time waveform of each signal in the turn-on of the switching element 11A. The highest section illustrates the time waveform of the low-side control signal IN_LS. The second section illustrates the time waveform of the voltage Vfb_LS. The third section illustrates a time waveform of the timing detection signal Vt_on1. The fourth section illustrates a time waveform of the timing detection signal Vt_on2. The fifth section illustrates the time waveform of the drive current Ig_LS.

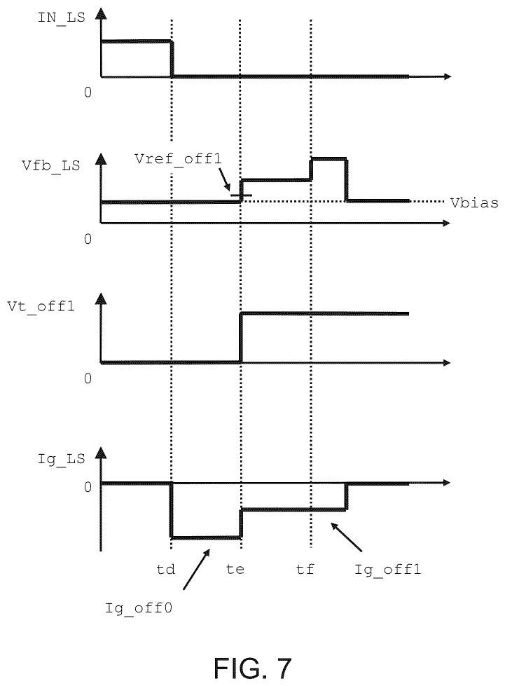

FIG. 7 is a diagram illustrating a time waveform of each signal in the turn-off of the switching element 11A. The highest section illustrates the time waveform of the low-side control signal IN_LS. The second section illustrates the time waveform of the voltage Vfb_LS. The third section illustrates a time waveform of the timing detection signal Vt_off1. The fourth section illustrates the time waveform of the drive current Ig_LS.

Referring to FIG. 6, at a timing when the voltage Vfb_LS falls below the threshold voltage Vref_on1 (first predetermined value), the timing detection signal Vt_on1 to be output from the comparator 23a changes from Lo (for example, 0 V) to Hi (for example, +5 V) (see Vfb_LS and Vt_on1 in FIG. 6). However, a relationship between Hi and Lo of the timing detection signal Vt_on1 may be opposite.

At a timing when the voltage Vfb_LS becomes higher than the threshold voltage Vref_on2 (second predetermined value), the timing detection signal Vt_on2 to be output from the comparator 23b changes from Lo (for example, 0 V) to Hi (for example, +5 V) (see Vfb_LS and Vt_on2 in FIG. 6). However, a relationship between Hi and Lo of the timing detection signal Vt_on2 may be opposite.

At a timing when the voltage Vfb_LS becomes higher than the threshold voltage Vref_off1 (third predetermined value), the timing detection signal Vt_off1 to be output from the comparator 23c changes from Lo (for example, 0 V) to Hi (for example, +5 V) (see Vfb_LS and Vt_off1 in FIG. 7). However, a relationship between Hi and Lo of the timing detection signal Vt_off1 may be opposite.

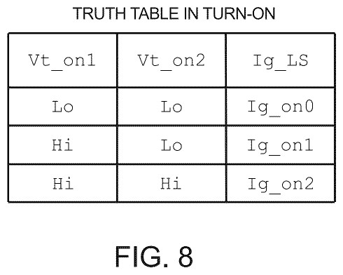

The first storage 24 in FIG. 4 stores the above-described current values Ig_on0, Ig_on1, and Ig_on2. The first multiplexer 25 selects any one of those three current values in accordance with a truth table in FIG. 8 and outputs the selected current value to the first variable current source 28. In detail, the first multiplexer 25 outputs the current value Ig_on0 in a period when Vt_on1=Lo and Vt_on2=Lo, outputs the current value Ig_on1 in a period when Vt_on1=Hi and Vt_on2=Lo, and outputs the current value Ig_on2 in a period when Vt_on1=Hi and Vt_on2=Hi.

The first variable current source 28 outputs the drive current Ig_LS having the current value to be output from the first multiplexer 25. The first switch 29 is turned ON only when the control signal IN_LS is Hi. Consequently, in the turn-on of the switching element 11A, a value of the drive current Ig_LS to be supplied from the low-side drive circuit 20A becomes Ig_on0 in the initial phase, becomes Ig_on1 in the first phase, and becomes Ig_on2 in the second phase.

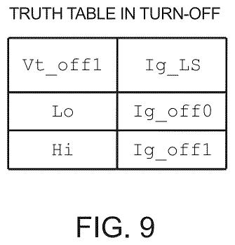

Similarly, the second storage 26 in FIG. 4 stores the above-described current values Ig_off0 and Ig_off1. The second multiplexer 27 selects either one of those two current values in accordance with a truth table in FIG. 9 and outputs the selected current value to the second variable current source 30. In detail, the second multiplexer 27 outputs the current value Ig_off0 in a period when Vt_off1=Lo and outputs the current value Ig_off1 in a period when Vt_off1=Hi.

The second variable current source 30 outputs the drive current Ig_LS having the current value to be output from the second multiplexer 27. The second switch 31 is turned ON only when the control signal IN_LS is Lo. Consequently, in the turn-off of the switching element 11A, the value of the drive current Ig_LS to be supplied from the low-side drive circuit 20A becomes Ig_off0 in the initial phase and becomes Ig_off1 in the third phase.

As described above, a drive circuit 20 according to the present first embodiment detects the transition timings (the time points ta, tb, and te) among the phases in the turn-on transition period (the period from the time points t0 to tc in FIG. 2) and the turn-off transition period (the period from the time points td to tf in FIG. 3) based on a voltage Vfb as a physical quantity which corresponds to a time change in an output current Id of a switching element 11.

In detail, the voltage Vfb is a voltage, which results from addition of the bias voltage Vbias to a voltage resulting from voltage division of the voltage VIs produced at both ends of the parasitic inductance Ls of the switching element 11 (i.e., the sum of the bias voltage Vbias and a voltage obtained by dividing the voltage VIs produced at both ends of the parasitic inductance Ls of the switching element 11), and the transition timing is detected as a timing when the voltage Vfb crosses each of the threshold voltages Vref_on1, Vref_on2, and Vref_off1. However, the physical quantity which corresponds to the time change in the output current Id of the switching element 11 is not limited to this. For example, a shunt resistance is connected to the power source PS of the switching element 11, a voltage produced at both ends of the shunt resistance is caused to pass through a high-pass filter functioning as a differentiator, and the physical quantity corresponding to the time change in the output current Id may thereby be acquired.

The drive circuit 20 changes a magnitude of a drive current Ig to be supplied to the switching element 11 at each of the transition timings, for example, switching the magnitude and thereby supplies the drive current Ig, whose magnitudes can respectively be different among the phases, to the switching element 11. Accordingly, the slew rate of an output voltage Vds of the switching element 11 can separately be controlled for each of the phases. That is, the slew rate of the output voltage Vds of the switching element 11 can flexibly and accurately be controlled.

### Second Embodiment

In the above first embodiment, in each of the phases in the turn-on transition period and the turn-off transition period, the magnitude of the drive current Ig to be supplied to the switching element 11 is a fixed value which is experimentally determined in advance. On the other hand, in the present second embodiment, the slew rate of the output voltage Vds in each phase is detected, and in accordance with a deviation between the slew rate and a predetermined target value, the magnitude of the drive current Ig in each phase is thereby controlled.

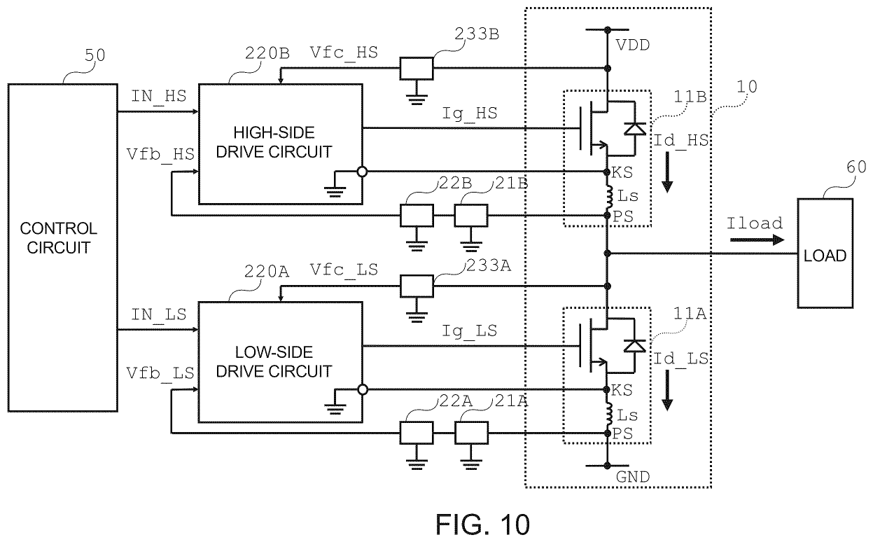

FIG. 10 is a diagram illustrating a configuration of a half-bridge inverter according to the second embodiment. The half-bridge inverter according to the second embodiment includes a low-side drive circuit 220A, a high-side drive circuit 220B, and attenuators 233A and 233B. The attenuator 233A is connected to the same ground as the low-side drive circuit 220A. The attenuator 233B is connected to the same ground as the high-side drive circuit 220B. Other configuration elements are similar to those of the first embodiment.

The attenuator 233A on the low side is configured with a capacitance or resistance, which is connected in series, for example, and outputs a voltage resulting from voltage division, at a predetermined ratio, of a voltage of the drain of the switching element 11A. Consequently, an output voltage Vfc_LS of the attenuator 233A is expressed by the following equation (11) by using a voltage Vds_LS between the drain and the source of the switching element 11A.

$$\begin{matrix}[ Math . 11 ] & \\ {V}_{fc} \_LS = {γV}_{ds} \_LS & ( 11 )\end{matrix}$$

However, in the above equation (11), “γ” represents a voltage division scale for the attenuator 233A and is set to a predetermined value in a range of 0<γ<1.

The above equation (11) expresses that the voltage Vfc_LS to be input to the low-side drive circuit 220A is a voltage which is proportional to the voltage Vds_LS between the drain and the source of the switching element 11A. In other words, the low-side drive circuit 220A can acquire the voltage Vfc_LS which is proportional to the voltage Vds_LS between the drain and the source of the switching element 11A. Similarly, the high-side drive circuit 220B can acquire a voltage Vfc_HS which is proportional to a voltage Vds_HS between the drain and the source of the switching element 11B.

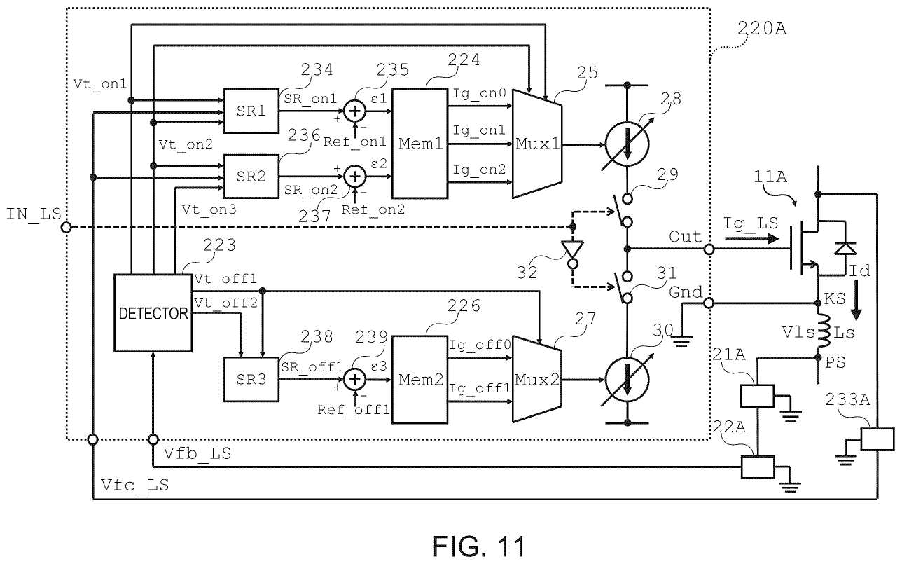

FIG. 11 is a diagram illustrating a detailed configuration of the low-side drive circuit 220A. Note that because a configuration of the high-side drive circuit 220B is similar, only the configuration of the low-side drive circuit 220A will be described in the following description. The low-side drive circuit 220A includes a transition timing detector (detector) 223, a first slew rate calculator (first calculator) 234 and a first adder 235, a second slew rate calculator (second calculator) 236 and a second adder 237, a third slew rate calculator (third calculator) 238 and a third adder 239, and a first storage 224 and a second storage 226. Other configuration elements are similar to those of the first embodiment.

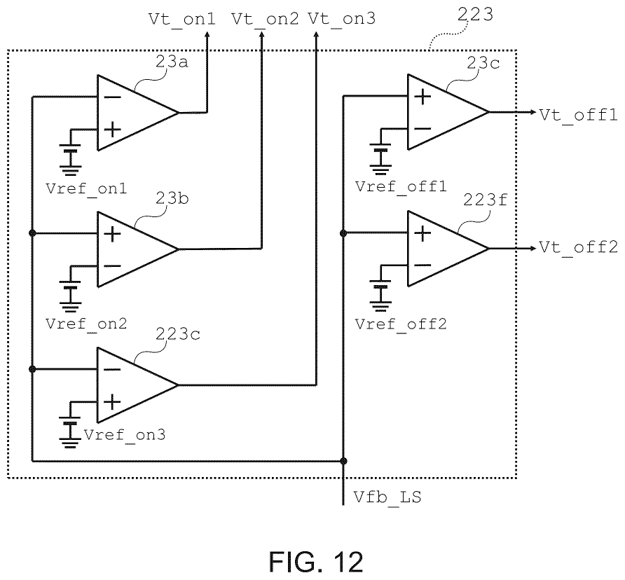

FIG. 12 is a diagram illustrating a detailed configuration of the transition timing detector 223. The transition timing detector 223 includes comparators 223c and 223f and constant voltage sources Vref_on3 and Vref_off2 in addition to each configuration element of the transition timing detector 23 of the first embodiment.

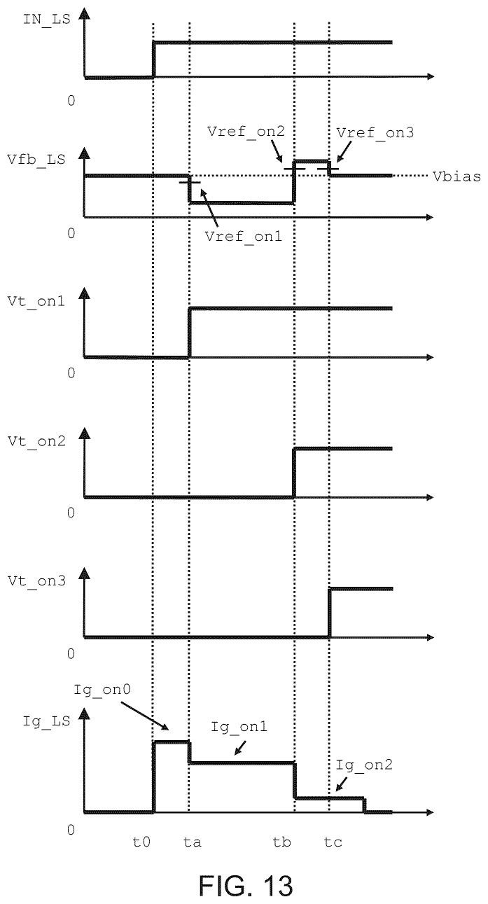

FIG. 13 is a diagram illustrating a time waveform of each signal in the turn-on of the switching element 11A. The highest section illustrates a time waveform of the low-side control signal IN_LS. The second section illustrates a time waveform of the voltage Vfb_LS. The third section illustrates a time waveform of the timing detection signal Vt_on1. The fourth section illustrates a time waveform of the timing detection signal Vt_on2. The fifth section illustrates a time waveform of a timing detection signal Vt_on3. The sixth section illustrates a time waveform of the drive current Ig_LS.

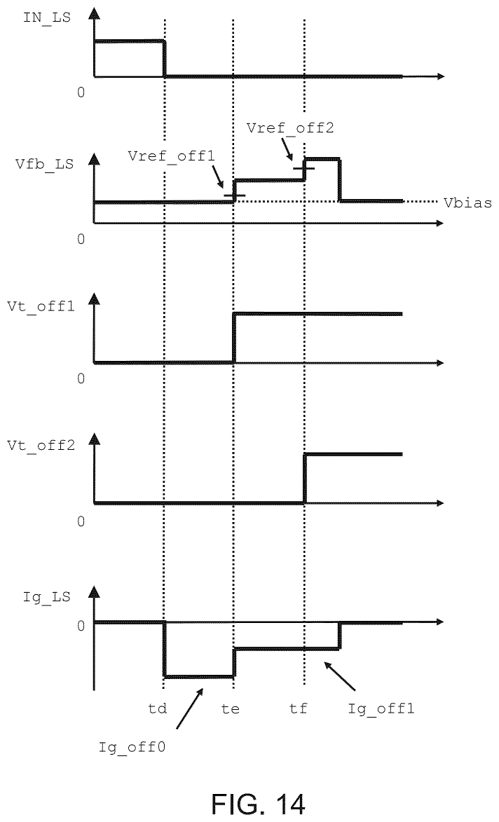

FIG. 14 is a diagram illustrating a time waveform of each signal in the turn-off of the switching element 11A. The highest section illustrates a time waveform of the low-side control signal IN_LS. The second section illustrates a time waveform of the voltage Vfb_LS. The third section illustrates a time waveform of the timing detection signal Vt_off1. The fourth section illustrates a time waveform of a timing detection signal Vt_off2. The fifth section illustrates a time waveform of the drive current Ig_LS.

Referring to FIG. 13, at a timing when the voltage Vfb_LS falls below a threshold voltage Vref_on3, the timing detection signal Vt_on3 to be output from the comparator 223c changes from Lo (for example, 0 V) to Hi (for example, +5 V) (see Vfb_LS and Vt_on3 in FIG. 13). The threshold voltage Vref_on3 is experimentally determined in advance so as to become a value suitable for detection of an end timing (the time point tc in FIG. 13) of the second phase in the turn-on transition period. Note that a relationship between Hi and Lo of the timing detection signal Vt_on3 may be opposite.

At a timing when the voltage Vfb_LS becomes higher than a threshold voltage Vref_off2, the timing detection signal Vt_off2 to be output from the comparator 223f changes from Lo (for example, 0 V) to Hi (for example, +5 V) (see Vfb_LS and Vt_off2 in FIG. 14). The threshold voltage Vref_off2 is experimentally determined in advance so as to become a value suitable for detection of an end timing (the time point tf in FIG. 14) of the third phase in the turn-off transition period. Note that a relationship between Hi and Lo of the timing detection signal Vt_off2 may be opposite.

Returning to FIG. 11, in the first phase (the time points ta to tb in FIG. 13) of the turn-on transition period of the switching element 11A, the first slew rate calculator 234 calculates a voltage slew rate SR_on1, which is defined by the above-described equation (8), based on the timing detection signals Vt_on1 and Vt_on2 and the voltage Vfc_LS.

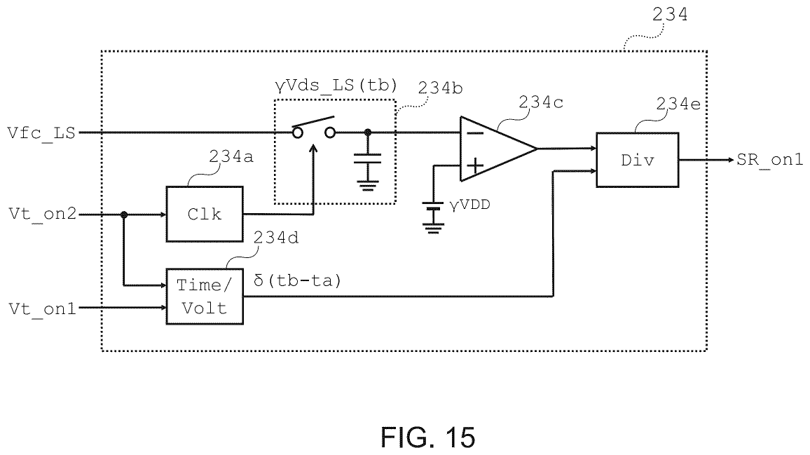

FIG. 15 is a diagram illustrating a detailed configuration of the first slew rate calculator 234. The first slew rate calculator 234 includes a clock generator 234a, a sample-and-hold circuit 234b configured with a switch and a capacitor, a differential amplifier 234c, a time-voltage conversion circuit 234d, and a divider 234e.

The clock generator 234a outputs one clock pulse while being synchronized with a timing when the timing detection signal Vt_on2 changes from Lo to Hi (the time point tb in FIG. 13). The sample-and-hold circuit 234b samples the voltage Vfc_LS by using, as a trigger, the clock pulse output from the clock generator 234a. Consequently, a hold voltage Vfc_LS (tb) of the sample-and-hold circuit 234b is expressed by the following equation (12).

$$\begin{matrix}[ Math . 12 ] & \\ {V}_{fc} \_LS ( {t}_{b} ) = {γV}_{ds} \_LS ( {t}_{b} ) & ( 12 )\end{matrix}$$

However, in the above equation (12), “γ” represents a voltage division scale for the attenuator 233A.

The differential amplifier 234c outputs a voltage which corresponds to a difference between the hold voltage Vfc_LS (tb) of the sample-and-hold circuit 234b and a predetermined voltage γVDD. Consequently, an output voltage Vdiff of the differential amplifier 234c is expressed by the following equation (13).

$$\begin{matrix}[ Math . 13 ] & \\ {V}_{diff} = g γ ( {V}_{DD} - {V}_{ds} \_LS ( {t}_{b} ) ) & ( 13 )\end{matrix}$$

However, in the above equation (13), “g” represents an amplification factor of the differential amplifier 234c, and “γ” represents the voltage division scale for the attenuator 233A. “VDD” represents the power source voltage of the half-bridge inverter.

The time-voltage conversion circuit 234d outputs a voltage which is proportional to a time from a timing when the timing detection signal Vt_on1 changes from Lo to Hi (the time point ta in FIG. 13) to a timing when the timing detection signal Vt_on2 changes from Lo to Hi (the time point tb in FIG. 13), that is, to a time of the first phase. Consequently, an output voltage Vcov of the time-voltage conversion circuit 234d is expressed by the following equation (14).

$$\begin{matrix}[ Math . 14 ] & \\ {V}_{c ov} = δ ( {t}_{b} - {t}_{a} ) & ( 14 )\end{matrix}$$

However, in the above equation (14), “δ” represents a predetermined proportionality coefficient.

The divider 234e outputs a value resulting from division of the output voltage Vdiff of the differential amplifier 234c by the output voltage Vcov of the time-voltage conversion circuit 234d. Consequently, an output value SR_on1 of the divider 234e is expressed by the following equation (15).

$$\begin{matrix}[ Math . 15 ] & \\ SR\_on1 = ( \frac{g γ}{δ} ) \frac{V DD - {V}_{ds} \_LS ( {t}_{b} )}{{t}_{b} - {t}_{a}} & ( 15 )\end{matrix}$$

In the above equation (15), because “gγ/δ” is a constant, the output value SR_on1 of the first slew rate calculator 234 becomes a value which is proportional to the voltage slew rate SR_on1 defined by the above-described equation (8).

The first adder 235 in FIG. 11 calculates a deviation 31 between the voltage slew rate SR_on1, which is calculated by the first slew rate calculator 234, and a predetermined target value Ref_on1. The first storage 224 corrects (overwrites) the current value Ig_on1 stored by the first storage 224 itself in accordance with the deviation ε1 calculated by the first adder 235.

In detail, in a case where the voltage slew rate SR_on1 in nth turn-on is higher than the target value Ref_on1, that is, in a case where the deviation ε1 is larger than 0, the first storage 224 corrects the current value Ig_on1 stored by the first storage 224 itself to a smaller current value corresponding to the deviation ε1. Accordingly, the drive current Ig_LS to be output from the variable current source 28 in n+1th turn-on becomes smaller than the drive current in the nth turn-on.

On the other hand, in a case where the voltage slew rate SR_on1 in the nth turn-on is lower than the target value Ref_on1, that is, in a case where the deviation ε1 is smaller than 0, the first storage 224 corrects the current value Ig_on1 stored by the first storage 224 itself to a larger current value corresponding to the deviation ε1. Accordingly, the drive current Ig_LS to be output from the variable current source 28 in the n+1th turn-on becomes larger than the drive current in the nth turn-on.

As described above, in the first phase of the turn-on transition period of the switching element 11A, the magnitude of the drive current Ig_LS to be output from the variable current source 28 is controlled in accordance with the deviation ε1 between the voltage slew rate SR_on1 and the target value Ref_on1. Note that the first storage 224 may as well correct (overwrite) the current value Ig_on0 stored by the first storage 224 itself in accordance with the deviation ε1 calculated by the first adder 235. For example, the first storage 224 may correct the current value Ig_on0 to the same value as the current value Ig_on1. Accordingly, in the initial phase of the turn-on transition period of the switching element 11A, the magnitude of the drive current Ig_LS to be output from the variable current source 28 is controlled in conjunction.

Similarly, in the second phase (the time points tb to tc in FIG. 13) of the turn-on transition period of the switching element 11A, the second slew rate calculator 236 calculates a voltage slew rate SR_on2, which is defined by the above-described equation (9), based on the timing detection signals Vt_on2 and Vt_on3 and the voltage Vfc_LS.

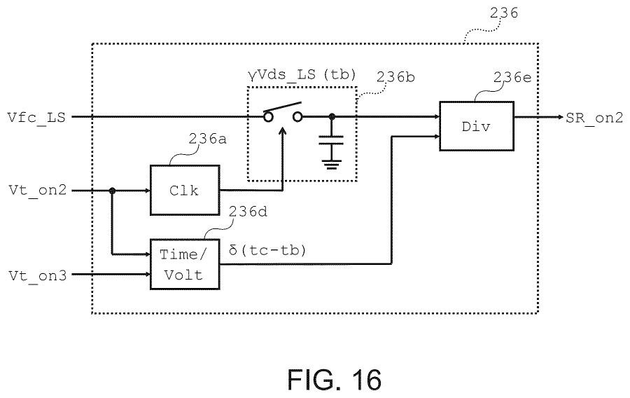

FIG. 16 is a diagram illustrating a detailed configuration of the second slew rate calculator 236. The second slew rate calculator 236 includes a clock generator 236a, a sample-and-hold circuit 236b configured with a switch and a capacitor, a time-voltage conversion circuit 236d, and a divider 236e.

The clock generator 236a outputs one clock pulse while being synchronized with a timing when the timing detection signal Vt_on2 changes from Lo to Hi (the time point tb in FIG. 13). The sample-and-hold circuit 236b samples the voltage Vfc_LS by using, as a trigger, the clock pulse output from the clock generator 236a. Consequently, a hold voltage Vfc_LS (tb) of the sample-and-hold circuit 236b is expressed by the following equation (16).

$$\begin{matrix}[ Math . 16 ] & \\ {V}_{fc} \_LS ( {t}_{b} ) = {γV}_{ds} \_LS ( {t}_{b} ) & ( 16 )\end{matrix}$$

However, in the above equation (16), “γ” represents the voltage division scale for the attenuator 233A.

The time-voltage conversion circuit 236d outputs a voltage which is proportional to a time from a timing when the timing detection signal Vt_on2 changes from Lo to Hi (the time point tb in FIG. 13) to a timing when the timing detection signal Vt_on3 changes from Lo to Hi (the time point tc in FIG. 13), that is, to a time of the second phase. Consequently, an output voltage Vcov of the time-voltage conversion circuit 236d is expressed by the following equation (17).

$$\begin{matrix}[ Math . 17 ] & \\ {V}_{c ov} = δ ( {t}_{c} - {t}_{b} ) & ( 17 )\end{matrix}$$

However, in the above equation (17), “δ” represents a predetermined proportionality coefficient.

The divider 236e outputs a value resulting from division of the hold voltage Vfc_LS (tb) of the sample-and-hold circuit 236b by the output voltage Vcov of the time-voltage conversion circuit 236d. Consequently, an output voltage SR_on2 of the divider 236e is expressed by the following equation (18).

$$\begin{matrix}[ Math . 18 ] & \\ SR\_on2 = ( \frac{γ}{δ} ) \frac{{V}_{ds} \_LS ( {t}_{b} )}{{t}_{c} - {t}_{b}} & ( 18 )\end{matrix}$$

In the above equation (18), because “γ/δ” is a constant, the output voltage SR_on2 of the second slew rate calculator 236 becomes a value which is proportional to the voltage slew rate SR_on2 defined by the above-described equation (9). Note that the divider 236e of the second slew rate calculator 236 may receive the hold voltage Vfc_LS (tb) from the sample-and-hold circuit 236b of the first slew rate calculator 234. In this case, the clock generator 236a and the sample-and-hold circuit 236b of the second slew rate calculator 236 can be omitted.

The second adder 237 in FIG. 11 calculates a deviation ε2 between the voltage slew rate SR_on2, which is calculated by the second slew rate calculator 236, and a predetermined target value Ref_on2. The first storage 224 corrects (overwrites) the current value Ig_on2 stored by the first storage 224 itself in accordance with the deviation ε2 calculated by the second adder 237. Accordingly, in the second phase of the turn-on transition period of the switching element 11A, the magnitude of the drive current Ig_LS to be output from the variable current source 28 is controlled in accordance with the deviation ε2 between the voltage slew rate SR_on2 and the target value Ref_on2.

Similarly, in the third phase (the time points te to tf in FIG. 14) of the turn-off transition period of the switching element 11A, the third slew rate calculator 238 calculates a voltage slew rate SR_off1, which is defined by the above-described equation (10), based on the timing detection signals Vt_off1 and Vt_off2.

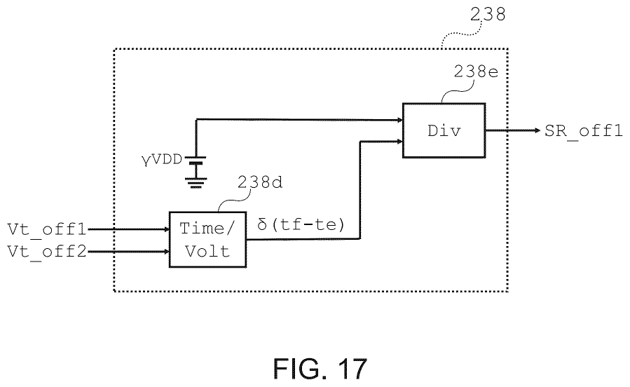

FIG. 17 is a diagram illustrating a detailed configuration of the third slew rate calculator 238. The third slew rate calculator 238 includes a time-voltage conversion circuit 238d and a divider 238e.

The time-voltage conversion circuit 238d outputs a voltage which is proportional to a time from a timing when the timing detection signal Vt_off1 changes from Lo to Hi (the time point te in FIG. 14) to a timing when the timing detection signal Vt_off2 changes from Lo to Hi (the time point tf in FIG. 14), that is, to a time of the third phase. Consequently, an output voltage Vcov of the time-voltage conversion circuit 238d is expressed by the following equation (19).

$$\begin{matrix}[ Math . 19 ] & \\ {V}_{c ov} = δ ( {t}_{f} - {t}_{e} ) & ( 19 )\end{matrix}$$

However, in the above equation (19), “δ” represents a predetermined proportionality coefficient.

The divider 238e outputs a value resulting from division of the predetermined voltage γVDD by the output voltage Vcov of the time-voltage conversion circuit 238d. Consequently, an output voltage SR_off1 of the divider 238e is expressed by the following equation (20).

$$\begin{matrix}[ Math . 20 ] & \\ SR\_off1 = ( \frac{γ}{δ} ) \frac{{V}_{DD}}{{t}_{f} - {t}_{e}} & ( 20 )\end{matrix}$$

In the above equation (20), because “γ/δ” is a constant, the output voltage SR_off1 of the third slew rate calculator 238 becomes a value which is proportional to the voltage slew rate SR_off1 defined by the above-described equation (10).

The third adder 239 in FIG. 11 calculates a deviation ε3 between the voltage slew rate SR_off1, which is calculated by the third slew rate calculator 238, and a predetermined target value Ref_off1. The second storage 226 corrects (overwrites) the current value Ig_off1 stored by the second storage 226 itself in accordance with the deviation ε3 calculated by the third adder 239. Accordingly, in the third phase of the turn-off transition period of the switching element 11A, the magnitude of the drive current Ig_LS to be output from the variable current source 30 is controlled in accordance with the deviation ε3 between the voltage slew rate SR_off1 and the target value Ref_off1.

As described above, a drive circuit 220 in the present second embodiment calculates the voltage slew rates SR_on1, SR_on2, and SR_off1 in the phases of the turn-on transition period and the turn-off transition period of a switching element 11 and controls a magnitude of a drive current Ig in the phases in accordance with the deviations between the voltage slew rates SR_on1, SR_on2, and SR_off1 and the target values Ref_on1, Ref_on2, and Ref_off1. Accordingly, the slew rate of an output voltage Vds of the switching element 11 can more accurately be controlled.

Note that not by calculating all of the voltage slew rates SR_on1, SR_on2, and SR_off1 but by calculating only any one or two of those, the current value related to the voltage slew rate, which is not calculated, may be set as a fixed value similarly to the first embodiment. For example, only the voltage slew rates SR_on1 and SR_on2 are calculated, and based on those, only the current values Ig_on1 and Ig_on2 may thereby be controlled. In this case, the current value Ig_off1 related to the voltage slew rate SR_off1 is set as a fixed value similarly to the first embodiment.

### Third Embodiment

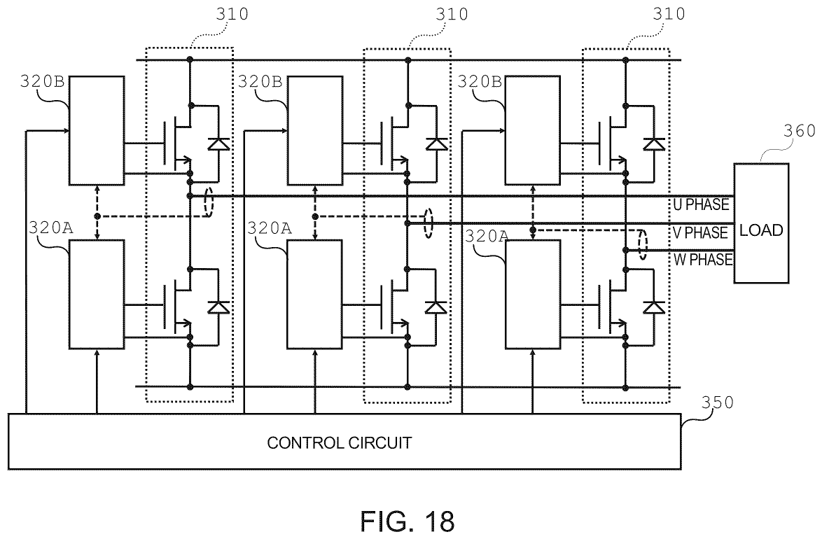

FIG. 18 is a diagram illustrating a configuration of a three-phase inverter according to a third embodiment. The three-phase inverter includes three half-bridge circuits 310, three low-side drive circuits 320A, three high-side drive circuits 320B, and a control circuit 350. A load 360 is connected to outputs of the three-phase inverter. Each of the half-bridge circuits 310 has the same configuration as the half-bridge circuit of the first or second embodiment. Each of the low-side drive circuits 320A has the same configuration as the low-side drive circuit of the first or second embodiment. Each of the high-side drive circuits 330B has the same configuration as the high-side drive circuit of the first or second embodiment.

The control circuit 350 supplies a low-side control signal to each of the low-side drive circuits 320A and supplies a high-side control signal to each of the high-side drive circuits 320B. The load 360 is an arbitrary electronic device or electric device which is driven by three-phase alternating-current power. For example, in a case where the load 360 is a three-phase alternating-current motor, the control circuit 350 supplies a PWM-modulated low-side control signal to each of the low-side drive circuits 320A and supplies a PWM-modulated high-side control signal to each of the high-side drive circuits 330B.

As another application example, an inverter which includes a low-side drive circuit, a high-side drive circuit, a half-bridge circuit, and a control circuit may be used as a PV inverter for solar photovoltaic generation. In this case, an output of the PV inverter is connected to an electricity network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

The embodiments as described before may be configured as below.

### CLAUSES

Clause 1. An electronic circuitry comprising:
   a detector configured to detect a physical quantity corresponding to a time change in an output current of a switching element whose driving is controlled in accordance with a control signal, and to compare the physical quantity with a predetermined value;
   a current supplier configured to supply a drive current to the switching element; and
   a controller configured to change a magnitude of the drive current supplied from the current supplier to the switching element in accordance with a comparison result between the physical quantity and the predetermined value.
Clause 2 The electronic circuitry according to clause 1, wherein the controller is configured to change the magnitude of the drive current supplied from the current supplier to the switching element at a transition timing corresponding to the comparison result.
Clause 3 The electronic circuitry according to clause 2, wherein
   the control signal is a turn-on signal instructing turn-on of the switching element,
   the predetermined value includes a first predetermined value and a second predetermined value,
   the electronic circuitry further comprises a first calculator configured to calculate a first slew rate of an output voltage of the switching element in a first phase which is a period from a first transition timing corresponding to a comparison result between the physical quantity and the first predetermined value to a second transition timing corresponding to a comparison result between the physical quantity and the second predetermined value in a turn-on transition period of the switching element, and
   the controller is configured to change the magnitude of the drive current supplied to the switching element in the first phase in accordance with the first slew rate.
Clause 4 The electronic circuitry according to clause 3, wherein the controller changes the magnitude of the drive current supplied to the switching element in an initial phase which is a period from a timing when the turn-on signal is supplied to before the first transition timing, in accordance with the first slew rate.
Clause 5 The electronic circuitry according to clause 3 or 4, wherein the first calculator includes:
   a clock generator configured to output a clock pulse in synchronization with the second transition timing;
   a sample-and-hold circuit configured to sample the output voltage of the switching element using the clock pulse as a trigger;
   a differential amplifier configured to output a voltage corresponding to a difference between a voltage held in the sample-and-hold circuit and a predetermined voltage;
   a time-voltage conversion circuit configured to output a voltage proportional to a time of the first phase; and
   a divider configured to output, as a value indicating the first slew rate, a value resulting from dividing the voltage output from the differential amplifier by the voltage output from the time-voltage conversion circuit.
Clause 6 The electronic circuitry according to any one of clauses 2 to 5, wherein
   the control signal is a turn-on signal instructing turn-on of the switching element,
   the predetermined value includes a second predetermined value,
   the electronic circuitry further comprises a second calculator configured to calculate a second slew rate of an output voltage of the switching element in a second phase which is a period after a second transition timing corresponding to a comparison result between the physical quantity and the second predetermined value in a turn-on transition period of the switching element, and
   the controller is configured to change the magnitude of the drive current supplied to the switching element in the second phase in accordance with the second slew rate.
Clause 7 The electronic circuitry according to clause 6, wherein the second calculator includes:
   a clock generator configured to output a clock pulse in synchronization with the second transition timing;
   a sample-and-hold circuit configured to sample the output voltage of the switching element using the clock pulse as a trigger;
   a time-voltage conversion circuit configured to output a voltage proportional to a time of the second phase; and
   a divider configured to output, as the value of the second slew rate, a value resulting from dividing the voltage held in the sample-and-hold circuit by the voltage output from the time-voltage conversion circuit.
Clause 8 The electronic circuitry according to any one of clauses 1 to 7, wherein
   the control signal is a turn-off signal instructing turn-off of the switching element,
   the predetermined value includes a third predetermined value,
   the electronic circuitry further comprises a third calculator configured to calculate a third slew rate of an output voltage of the switching element in a third phase which is a period after a third transition timing corresponding to a comparison result between the physical quantity and the third predetermined value in a turn-off transition period of the switching element, and
   the controller is configured to change the magnitude of the drive current supplied to the switching element in the third phase in accordance with the third slew rate.
Clause 9 The electronic circuitry according to clause 8, wherein the third calculator includes:
   a time-voltage conversion circuit configured to output a voltage proportional to a time of the third phase; and
   a divider configured to output, as the third slew rate, a value resulting from dividing a predetermined voltage by the voltage output from the time-voltage conversion circuit.
Clause 10 The electronic circuitry according to any one of clauses 1 to 9, wherein the physical quantity corresponding to the time change in the output current is a voltage generated across a parasitic inductance of the switching element.
Clause 11 The electronic circuitry according to clause 10, wherein the switching element is a MOSFET, and the voltage generated across the parasitic inductance is a voltage between a Kelvin source terminal and a power source terminal of the MOSFET.
Clause 12 The electronic circuitry according to clause 10, wherein the switching element is an IGBT, and the voltage generated across the parasitic inductance is a voltage between a Kelvin emitter terminal and a power emitter terminal of the IGBT.
Clause 13 The electronic circuitry according to any one of clauses 1 to 12, wherein the detector includes:
   an attenuator configured to output a voltage obtained by dividing a voltage corresponding to the time change in the output current;
   a bias circuit configured to output a sum of a predetermined voltage and the voltage output from the attenuator; and
   a comparator configured to compare the sum with the predetermined value.
Clause 14 A power converter comprising:
   a half-bridge circuit including two switching elements; and
   two drive circuits configured to respectively drive the two switching elements in accordance with control signals,
   wherein each of the two drive circuits includes:
   a detector configured to detect a physical quantity corresponding to a time change in an output current of the switching element controlled by the drive circuit itself, and to compare the physical quantity with a predetermined value;
   a current supplier configured to supply a drive current to the switching element; and
   a controller configured to change a magnitude of the drive current supplied from the current supplier to the switching element in accordance with a comparison result between the physical quantity and the predetermined value.
Clause 15 A three-phase inverter comprising three power converters according to clause 14.
Clause 16 A driving method comprising:
   detecting a physical quantity corresponding to a time change in an output current of a switching element whose driving is controlled in accordance with a control signal, and
   comparing the physical quantity with a predetermined value; and changing a magnitude of a drive current supplied from a current supplier to the switching element in accordance with a comparison result between the physical quantity and the predetermined value.

1. An electronic circuitry comprising:
a detector configured to detect a physical quantity corresponding to a time change in an output current of a switching element whose driving is controlled in accordance with a control signal, and to compare the physical quantity with a predetermined value;
a current supplier configured to supply a drive current to the switching element; and
a controller configured to change a magnitude of the drive current supplied from the current supplier to the switching element in accordance with a comparison result between the physical quantity and the predetermined value.

2. The electronic circuitry according to claim 1, wherein the controller is configured to change the magnitude of the drive current supplied from the current supplier to the switching element at a transition timing corresponding to the comparison result.

3. The electronic circuitry according to claim 2, wherein
the control signal is a turn-on signal instructing turn-on of the switching element,
the predetermined value includes a first predetermined value and a second predetermined value,
the electronic circuitry further comprises a first calculator configured to calculate a first slew rate of an output voltage of the switching element in a first phase which is a period from a first transition timing corresponding to a comparison result between the physical quantity and the first predetermined value to a second transition timing corresponding to a comparison result between the physical quantity and the second predetermined value in a turn-on transition period of the switching element, and
the controller is configured to change the magnitude of the drive current supplied to the switching element in the first phase in accordance with the first slew rate.

4. The electronic circuitry according to claim 3, wherein the controller changes the magnitude of the drive current supplied to the switching element in an initial phase which is a period from a timing when the turn-on signal is supplied to before the first transition timing, in accordance with the first slew rate.

5. The electronic circuitry according to claim 3, wherein the first calculator includes:
a clock generator configured to output a clock pulse in synchronization with the second transition timing;
a sample-and-hold circuit configured to sample the output voltage of the switching element using the clock pulse as a trigger;
a differential amplifier configured to output a voltage corresponding to a difference between a voltage held in the sample-and-hold circuit and a predetermined voltage;
a time-voltage conversion circuit configured to output a voltage proportional to a time of the first phase; and
a divider configured to output, as a value indicating the first slew rate, a value resulting from dividing the voltage output from the differential amplifier by the voltage output from the time-voltage conversion circuit.

6. The electronic circuitry according to claim 2, wherein
the control signal is a turn-on signal instructing turn-on of the switching element,
the predetermined value includes a second predetermined value,
the electronic circuitry further comprises a second calculator configured to calculate a second slew rate of an output voltage of the switching element in a second phase which is a period after a second transition timing corresponding to a comparison result between the physical quantity and the second predetermined value in a turn-on transition period of the switching element, and
the controller is configured to change the magnitude of the drive current supplied to the switching element in the second phase in accordance with the second slew rate.

7. The electronic circuitry according to claim 6, wherein the second calculator includes:
a clock generator configured to output a clock pulse in synchronization with the second transition timing;
a sample-and-hold circuit configured to sample the output voltage of the switching element using the clock pulse as a trigger;
a time-voltage conversion circuit configured to output a voltage proportional to a time of the second phase; and
a divider configured to output, as the value of the second slew rate, a value resulting from dividing the voltage held in the sample-and-hold circuit by the voltage output from the time-voltage conversion circuit.

8. The electronic circuitry according to claim 1, wherein
the control signal is a turn-off signal instructing turn-off of the switching element,
the predetermined value includes a third predetermined value,
the electronic circuitry further comprises a third calculator configured to calculate a third slew rate of an output voltage of the switching element in a third phase which is a period after a third transition timing corresponding to a comparison result between the physical quantity and the third predetermined value in a turn-off transition period of the switching element, and
the controller is configured to change the magnitude of the drive current supplied to the switching element in the third phase in accordance with the third slew rate.

9. The electronic circuitry according to claim 8, wherein the third calculator includes:
a time-voltage conversion circuit configured to output a voltage proportional to a time of the third phase; and
a divider configured to output, as the third slew rate, a value resulting from dividing a predetermined voltage by the voltage output from the time-voltage conversion circuit.

10. The electronic circuitry according to claim 1, wherein the physical quantity corresponding to the time change in the output current is a voltage generated across a parasitic inductance of the switching element.

11. The electronic circuitry according to claim 10, wherein the switching element is a MOSFET, and the voltage generated across the parasitic inductance is a voltage between a Kelvin source terminal and a power source terminal of the MOSFET.

12. The electronic circuitry according to claim 10, wherein the switching element is an IGBT, and the voltage generated across the parasitic inductance is a voltage between a Kelvin emitter terminal and a power emitter terminal of the IGBT.

13. The electronic circuitry according to claim 1, wherein the detector includes:
an attenuator configured to output a voltage obtained by dividing a voltage corresponding to the time change in the output current;
a bias circuit configured to output a sum of a predetermined voltage and the voltage output from the attenuator; and
a comparator configured to compare the sum with the predetermined value.

14. A power converter comprising:
a half-bridge circuit including two switching elements; and
two drive circuits configured to respectively drive the two switching elements in accordance with control signals,
wherein each of the two drive circuits includes:
a detector configured to detect a physical quantity corresponding to a time change in an output current of the switching element controlled by the drive circuit itself, and to compare the physical quantity with a predetermined value;
a current supplier configured to supply a drive current to the switching element; and
a controller configured to change a magnitude of the drive current supplied from the current supplier to the switching element in accordance with a comparison result between the physical quantity and the predetermined value.

15. A three-phase inverter comprising three power converters according to claim 14.

16. A driving method comprising:
detecting a physical quantity corresponding to a time change in an output current of a switching element whose driving is controlled in accordance with a control signal, and
comparing the physical quantity with a predetermined value; and changing a magnitude of a drive current supplied from a current supplier to the switching element in accordance with a comparison result between the physical quantity and the predetermined value.
